(19) United States
(12) Patent Application Publication
(10) Pub. No.: US 2026/0009998 A1
(43) Pub. Date: Jan. 8, 2026

(54) PRISM MOTOR MODULE

(71) Applicant: GUANGZHOU LUXVISIONS INNOVATION TECHNOLOGY LIMITED, Guangzhou City (CN)

(72) Inventors: Ling Zeng, Guangzhou City (CN); Zhuo-Hong Li, Guangzhou City (CN); Jia-Dong Zhang, Guangzhou City (CN)

(73) Assignee: GUANGZHOU LUXVISIONS INNOVATION TECHNOLOGY LIMITED, Guangzhou City (CN)

(21) Appl. No.: 19/324,269

(22) Filed: Sep. 10, 2025

(30) Foreign Application Priority Data
Dec. 31, 2024 (CN) 202411997417.X

(51) Int. Cl. G02B 26/08; G02B 7/18; G02B 13/00; G03B 13/36; G03B 30/00

(52) U.S. Cl. CPC G02B 26/0883; G02B 7/1805; G02B 13/0065; G03B 13/36; G03B 30/00; G03B 2205/003; G03B 2205/0069

(57) ABSTRACT

A prism motor module includes a fixing base, a coil assembly, a prism bracket, a prism carrier, a prism, and a limiting structure. The fixing base includes a body, a driving module, two balls, and a limiting groove. The driving module includes a first coil assembly and a second coil assembly. The prism bracket is arranged on the fixing base and includes a first magnet module and a guide shaft. The first magnet module corresponds to the first coil assembly, and the guide shaft correspondingly abuts against the limiting groove. The prism carrier is arranged on the prism bracket and includes a second magnet module corresponding to the second coil assembly. The limiting structure is arranged between the prism bracket and the prism carrier, to restrict movement of the prism carrier on a plane formed by the second axis and a third axis.

### CROSS-REFERENCE TO RELATED APPLICATION

This non-provisional application claims priority under 35 U.S.C. § 119 (a) to patent application No. 202411997417.X filed in China on Dec. 31, 2024, the entire contents of which are hereby incorporated by reference.

### BACKGROUND

### Technical Field

The present invention relates to a prism motor module, and in particular, to a prism motor module used in a periscope image capturing device to drive a prism into motion.

### Related Art

In a periscope image capturing device, an image is formed on a sensor through a prism and a lens. The lens is equipped with a motor for an auto focus (AF) function, and the prism motor provides an optical image stabilization (OIS) function. Specifically, the prism motor may control different movable members through different magnetic systems to achieve rotational motion in different axial directions, so as to compensate for rotation angles required in different axial directions. However, an existing structure may cause excessive dynamic and static friction when the movable members move relative to each other, resulting in a problem of jitter when switching at small angles.

### SUMMARY

In view of this, a prism motor module is provided according to an embodiment, including a fixing base, a coil assembly, a prism bracket, a prism carrier, a prism, and a limiting structure. The fixing base includes a body, a driving module, two balls, and a limiting groove. The body has a bottom surface and a side surface perpendicular to the bottom surface. The driving module includes a first coil assembly and a second coil assembly. The first coil assembly is arranged on the bottom surface, and the second coil assembly is arranged on the side surface. The two balls are respectively arranged on two opposite sides of the bottom surface of the body. The limiting groove is provided on the bottom surface of the body. The prism bracket is arranged on the fixing base. The prism bracket includes a first magnet module and a guide shaft. The first magnet module corresponds to the first coil assembly, and the guide shaft correspondingly abuts against the limiting groove, causing the prism bracket to rotate around a first axis with the guide shaft as an axis. The prism carrier is arranged on the prism bracket. The prism carrier includes a second magnet module corresponding to the second coil assembly, causing the prism carrier to rotate around a second axis, and the second axis is perpendicular to the first axis. The prism is arranged on the prism carrier. The limiting structure is arranged between the prism bracket and the prism carrier, to restrict movement of the prism carrier on a plane formed by the second axis and a third axis. The third axis is perpendicular to the first axis and the second axis.

In addition, a prism motor module is provided according to another embodiment, including a fixing base, a coil assembly, a prism bracket, a prism carrier, a prism, and a limiting structure. The fixing base includes a body, a driving module, a plurality of balls, and a limiting groove. The body has a bottom surface and a side surface perpendicular to the bottom surface. The driving module includes a first coil assembly and a second coil assembly. The first coil assembly is arranged on the bottom surface, and the second coil assembly is arranged on the side surface. At least two of the plurality of balls are arranged on one side of the bottom surface of the body, and at least other two of the plurality of balls are arranged on the other side of the bottom surface of the body. The prism bracket is arranged on the fixing base. The prism bracket includes a first magnet module and a guide shaft. The first magnet module corresponds to the first coil assembly, and the guide shaft correspondingly abuts against the limiting groove, causing the prism bracket to rotate around a first axis with the guide shaft as an axis. The prism carrier is arranged on the prism bracket. The prism carrier includes a second magnet module corresponding to the second coil assembly, causing the prism carrier to rotate around a second axis, and the second axis is perpendicular to the first axis. The prism is arranged on the prism carrier. The limiting structure is arranged between the prism bracket and the prism carrier, to restrict movement of the prism carrier on a plane formed by the second axis and a third axis.

The third axis is perpendicular to the first axis and the second axis.

In an embodiment, the limiting structure includes a first accommodating groove, a first rolling member, a second accommodating groove, and a second rolling member. The first accommodating groove and the first rolling member are correspondingly provided on one side of the prism bracket and the prism carrier on the second axis, and the first rolling member rolls in the first accommodating groove. The second accommodating groove and the second rolling member are correspondingly provided on the other side of the prism bracket and the prism carrier on the second axis, and the second rolling member rolls in the second accommodating groove.

In an embodiment, the first accommodating groove and the second accommodating groove are respectively provided on one of the prism bracket and the prism carrier, and the first rolling member and the second rolling member are respectively arranged on the other of the prism bracket and the prism carrier.

In an embodiment, the first rolling member is a metal ball or a ceramic ball.

In an embodiment, the first rolling member is a metal roller or a ceramic roller, and an axial direction of the first rolling member is parallel to the second axis.

In an embodiment, the second rolling member is a metal ball or a ceramic ball.

In an embodiment, the second rolling member is a metal roller, an axial direction of the second rolling member is parallel to the second axis, and the second accommodating groove is a V-shaped groove or a circular arc groove.

In an embodiment, the fixing base further includes a magnetic attraction member arranged on the bottom surface and located below the first coil assembly.

In an embodiment, the prism carrier further includes a magnet, and the prism bracket further includes a magnetic attraction member. The magnet and the magnetic attraction member are arranged in corresponding positions.

In an embodiment, the guide shaft is in the shape of a metal column or a ceramic column, and an end surface abutting against the limiting groove is in the shape of a circular arc surface.

Based on the above, the prism motor module of this application enables contact between the fixing base and the movable member such as the prism bracket and between the prism bracket and the movable member such as the prism carrier to be achieved through the ball, the guide shaft, or the rolling member. By replacing surface contact with point contact, the dynamic and static friction between the fixing base, the prism bracket, and the prism carrier during relative motion is reduced to alleviate the problem of jitter in the OIS function structure that may be caused by the motor when switching at small angles due to the dynamic and static friction. In addition, through the ball, the rolling member, or the guide shaft made of metal or a ceramic material, the friction may be further reduced, and structural strength may be increased.

Detailed features and advantages of the present invention are described in detail in the following implementations, and the content is sufficient for any person skilled in the related art to understand the technical content of the present invention and implement the invention accordingly. According to the content, the claims scope, and the figures disclosed in this specification, any person skilled in the related art can easily understand related objectives and advantages of the embodiments of the present invention.

### BRIEF DESCRIPTION OF THE DRAWINGS

FIG. 1 is a three-dimensional view of a prism motor module according to a first embodiment.

FIG. 2 is a three-dimensional exploded view of a prism motor module according to a first embodiment.

FIG. 3 is a three-dimensional exploded view of a fixing base and a prism bracket according to a first embodiment.

FIG. 4 is a three-dimensional exploded view of a prism bracket and a prism carrier according to a first embodiment.

FIG. 5 is a schematic diagram showing that a prism bracket according to a first embodiment is arranged on a prism carrier but separated from a fixing base.

FIG. 6 is a three-dimensional exploded view of a fixing base and a prism bracket according to a second embodiment.

### DETAILED DESCRIPTION

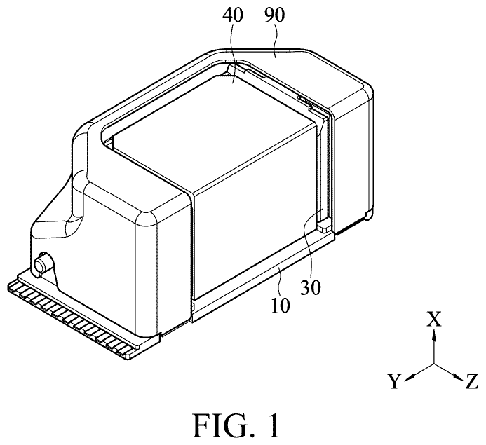

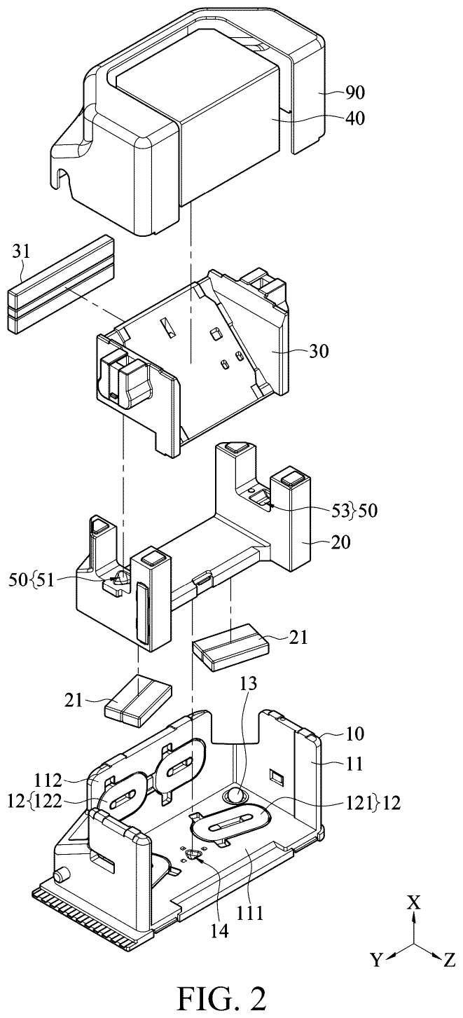

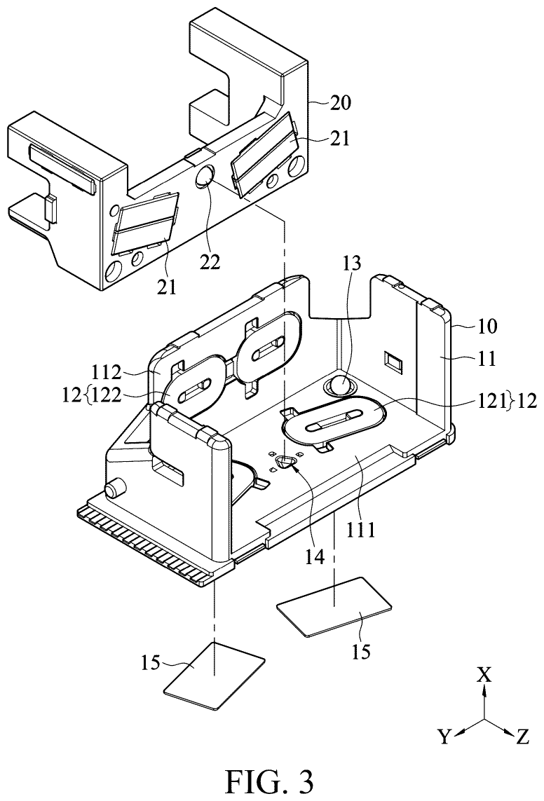

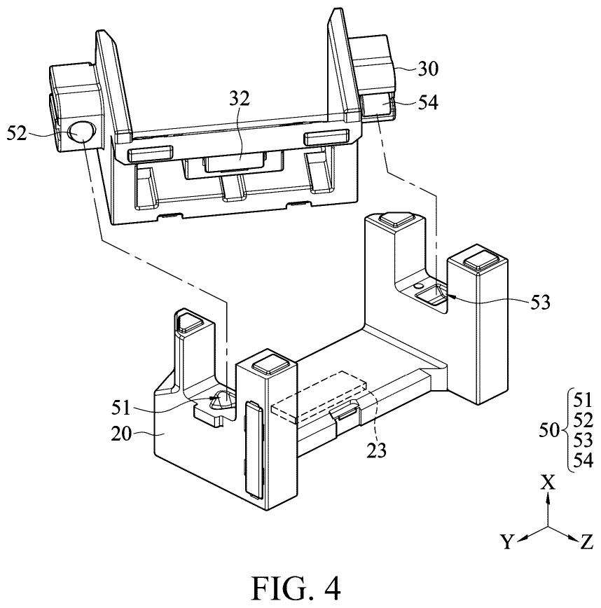

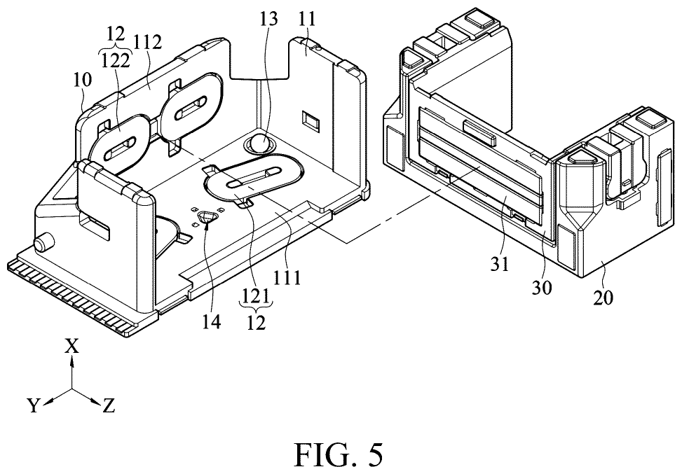

First refer to FIG. 1 to FIG. 5. FIG. 1 is a three-dimensional view of a prism motor module according to a first embodiment, FIG. 2 is a three-dimensional exploded view of a prism motor module according to a first embodiment, FIG. 3 is a three-dimensional exploded view of a fixing base and a prism bracket according to a first embodiment, FIG. 4 is a three-dimensional exploded view of a prism bracket and a prism carrier according to a first embodiment, and FIG. 5 is a schematic diagram showing that a prism bracket according to a first embodiment is arranged on a prism carrier but separated from a fixing base. The prism motor module of this embodiment may be applied to a periscope image capturing device such as a mobile phone camera device, an augmented reality device, or an on-board camera device with image auto focus and optical image stabilization (OIS) functions. In addition, to facilitate subsequent description, a direction extending along a height of the prism motor module is set as a first axis X, a direction extending along a long side of the prism motor module is set as a second axis Y, and a direction extending along a short side of the prism motor module is set as a third axis Z. The first axis X, the second axis Y, and the third axis Z are perpendicular to each other. Furthermore, as shown in FIG. 1 and FIG. 2, to prevent internal assemblies of the prism motor module during motion from being disturbed by external elements and maintain overall aesthetics, a housing 90 may be arranged on an outermost side of the prism motor module to cover the entire prism motor module.

It may be seen from FIG. 2 that the prism motor module of this embodiment includes a fixing base 10, a prism bracket 20, a prism carrier 30, a prism 40, and a limiting structure 50. The fixing base 10 includes a body 11, a driving module 12, two balls 13, and a limiting groove 14. The body 11 has a bottom surface 111 and a side surface 112 perpendicular to the bottom surface 111. The driving module 12 includes a first coil assembly 121 and a second coil assembly 122. The first coil assembly 121 is arranged on the bottom surface 111, and the second coil assembly 122 is arranged on the side surface 112. The first coil assembly 121 and the second coil assembly 122 may both be formed by two sets of coils arranged on the bottom surface 111 and the side surface 112 in a bilateral symmetry manner, or may be formed by fewer or more sets of coils, which are configured as required.

The two balls 13 are respectively arranged on two opposite sides of the bottom surface 111 of the body 11. The ball 13 on a left side in FIG. 2 is occluded and not shown, but in fact, the same ball 13 is arranged in a symmetrical upper left corner position. The limiting groove 14 is provided on the bottom surface 111 of the body 11.

Refer to FIG. 2 and FIG. 3 together. The prism bracket 20 is arranged on the fixing base 10, and the prism bracket 20 includes a first magnet module 21 and a guide shaft 22. An arrangement position of the first magnet module 21 corresponds to an arrangement position of the first coil assembly 121 on the bottom surface 111, and a quantity of first magnet modules 21 is also set corresponding to a quantity of first coil assemblies 121. In this embodiment, since the first coil assembly 121 has two sets of coils arranged diagonally on the left and right, the first magnet module 21 also corresponds to two sets of magnets arranged diagonally on the left and right. Each set of magnets have positive and negative poles.

The guide shaft 22 is fixedly arranged on a bottom side of the prism bracket 20 and correspondingly abuts against the limiting groove 14, so that the prism bracket 20 can rotate around the first axis X with the guide shaft 22 as an axis after being arranged on the fixing base 10. A center of the guide shaft 22 is arranged at a central extension of the corresponding prism 40, and is matched with the limiting groove 14 on the fixing base 10. In other words, a position of the limiting groove 14 provided on the bottom surface 111 corresponds to an arrangement position of the guide shaft 22. In addition to guiding the guide shaft 22 to rotate in the limiting groove 14, a movement range of the guide shaft 22 that may move during the rotation may also be limited. In this embodiment, the guide shaft 22 may be in the shape of a metal column or a ceramic column to be embedded in the prism bracket 20, and an end surface of the guide shaft 22 that abuts against the limiting groove 14 is in the shape of a circular arc surface.

In addition, the two balls 13 arranged on the fixing base 10 are also in contact with the bottom side of the prism bracket 20, thereby providing two more points of support for the prism bracket 20 in addition to the guide shaft 22. In this way, by replacing surface contact with point contact between the fixing base 10 and the prism bracket 20, the dynamic and static friction between the fixing base 10 and the prism bracket 20 during relative motion is reduced to alleviate the problem of jitter in the OIS function structure that may be caused by the motor when switching at small angles due to the dynamic and static friction.

Next, still refer to FIG. 2 and FIG. 5. The prism carrier 30 is arranged on the prism bracket 20. The prism carrier 30 includes a second magnet module 31 corresponding to the second coil assembly 122, causing the prism carrier 30 to rotate around a second axis Y. The second magnet module 31 is arranged on a back side of the prism carrier 30. The prism 40 is arranged on the prism carrier 30. As shown in FIG. 5, when the prism carrier 30 is arranged on the prism bracket 20, the second magnet module 31 is still exposed from the back side. When the prism carrier 30 is arranged on the prism bracket 20 and then arranged on the fixing base 10, the second magnet module 31 corresponds to the second coil assembly 122. In this embodiment, the second coil assembly 122 is formed by two sets of coils arranged on the side surface 112 in a bilateral symmetry manner, but the second magnet module 31 is a set of long strip-shaped magnets extending to correspond to the entire second coil assembly 122. In another implementation, a quantity of second magnet modules 31 may also be set corresponding to a quantity of second coil assemblies 122, and correspondingly arranged in the same manner as the first magnet module 21.

It may be seen from FIG. 2 and FIG. 4 that the limiting structure 50 is arranged between the prism bracket 20 and the prism carrier 30, to restrict movement of the prism carrier 30 on a plane formed by the second axis Y and the third axis Z, that is, restrict movement of the prism carrier 30 on a horizontal plane.

In this way, in the prism motor module of this embodiment, the prism 40 rotates around the first axis X through the first coil assembly 121, the first magnet module 21, and the guide shaft 22 arranged between the fixing base 10 and the prism bracket 20. The prism 40 rotates around the second axis Y through the second coil assembly 122, the second magnet module 31, and the limiting structure 50 arranged between the prism bracket 20 and the prism carrier 30. Further, the contact between the fixing base 10 and the prism bracket 20 is achieved through the ball 13 and the guide shaft 22. In addition, the prism bracket 20 and the prism carrier 30 may also be arranged through the limiting structure 50 in a point contact or line contact manner. In this way, by replacing surface contact with point contact or line contact, the dynamic and static friction between the fixing base 10, the prism bracket 20, and the prism carrier 30 during relative motion is reduced to alleviate the problem of jitter in the OIS function structure that may be caused by the motor when switching at small angles due to the dynamic and static friction.

Next, refer to FIG. 2 and FIG. 4 together. The limiting structure 50 includes a first accommodating groove 51, a first rolling member 52, a second accommodating groove 53, and a second rolling member 54. The first accommodating groove 51 and the first rolling member 52 are correspondingly provided on one side of the prism bracket 20 and the prism carrier 30 on the second axis Y, and the first rolling member 52 rolls in the first accommodating groove 51. The second accommodating groove 53 and the second rolling member 54 are correspondingly provided on the other side of the prism bracket 20 and the prism carrier 30 on the second axis Y, and the second rolling member 54 rolls in the second accommodating groove 53.

The first accommodating groove 51 and the second accommodating groove 53 may be respectively provided on one of the prism bracket 20 and the prism carrier 30, and the first rolling member 52 and the second rolling member 54 are respectively arranged on the other of the prism bracket 20 and the prism carrier 30. In this embodiment, it may be seen from FIG. 4 that the first accommodating groove 51 and the second accommodating groove 53 are respectively provided on opposite left and right sides of the prism bracket 20. The first rolling member 52 and the second rolling member 54 are arranged on opposite left and right sides of the prism carrier 30. In addition, the arrangement manner is not limited to providing the accommodating grooves on the prism bracket 20 or the prism carrier 30. Alternatively, the first accommodating groove 51 is provided in the prism bracket 20, the second accommodating groove 53 is provided in the prism carrier 30, and the rolling member is correspondingly arranged in the other one accordingly.

Further, it may be seen from FIG. 4 that in this embodiment, the first rolling member 52 is a metal ball or a ceramic ball and is fixed to the prism carrier 30, and the first accommodating groove 51 is a triangular groove and is provided in the prism bracket 20. In application, a shape of the first accommodating groove 51 is not limited to a triangular groove, or may be a square groove, a semi-circular groove, or the like, as long as the groove may restrict the movement of the first rolling member 52 in directions of the first axis X and the third axis Z. When the prism carrier 30 rotates around the second axis Y relative to the prism bracket 20, if a displacement on the plane is generated, a range of motion of the prism carrier on the plane formed by the first axis X and the third axis Z (that is, a horizontal plane) may also be controlled under mutual limitation of the first accommodating groove 51 and the first rolling member 52.

In addition, in this embodiment, the second rolling member 54 is a metal roller or a ceramic roller, an axial direction of the second rolling member 54 is parallel to the second axis Y, and the second accommodating groove 53 is correspondingly a V-shaped groove or a circular arc groove. The shape of the second accommodating groove 53 is only given as an example. In application, any shape may be used to allow the second rolling member 54 of the metal roller or the ceramic roller to roll smoothly therein, and the shape is not limited. The second rolling member 54 is in the form of a metal roller or a ceramic roller, which may provide relative movement between the prism bracket 20 and the prism carrier 30 in the form of line contact when the prism carrier 30 rotates around the second axis Y relative to the prism bracket 20, thereby reducing friction. In addition, through the balls or rollers made of metal or the ceramic material, the structural strength may be increased while further reducing friction.

In addition, in this embodiment, an example in which the first rolling member 52 is a metal ball or a ceramic ball, the first accommodating groove 51 is a triangular groove, the second rolling member 54 is a metal roller or a ceramic roller, and the second accommodating groove 53 is a V-shaped groove or a circular arc groove is used. However, in another implementation, the rolling members may also be all balls, and the accommodating grooves are all triangular grooves, square grooves, or semi-circular grooves. Alternatively, the rolling members are all rollers, and the accommodating grooves are all V-shaped grooves or circular arc grooves. In this way, the effect of increasing structural strength may also be achieved while reducing friction.

Next, referring to FIG. 3, the fixing base 10 further includes a magnetic attraction member 15 arranged on the bottom surface 111 and located below the first coil assembly 121. The magnetic attraction member 15 and the first magnet module 21 arranged on the bottom of the prism bracket 20 attract each other to press the guide shaft 22 and the ball 13, to ensure that during the motion, disengagement or mutual separation and misalignment between the fixing base 10 and the prism bracket 20 are prevented.

In addition, referring to FIG. 4, the prism carrier 30 further includes a magnet 32, and the prism bracket 20 further includes another magnetic attraction member 23. The magnet 32 and another magnetic attraction member 23 are arranged in corresponding positions. The magnetic attraction member 23 on the prism bracket 20 may be directly embedded in the prism bracket 20 through insert molding. The magnet 32 arranged on the prism carrier 30 and the magnetic attraction member 23 on the prism bracket 20 mutually attract each other, to press the first rolling member 52 and the second rolling member 54 toward the first accommodating groove 51 and second accommodating groove 53, to ensure that during the relative motion, disengagement between the prism carrier 30 and the prism bracket 20 or mutual separation and misalignment between the prism carrier 30 and the prism bracket 20 are prevented.

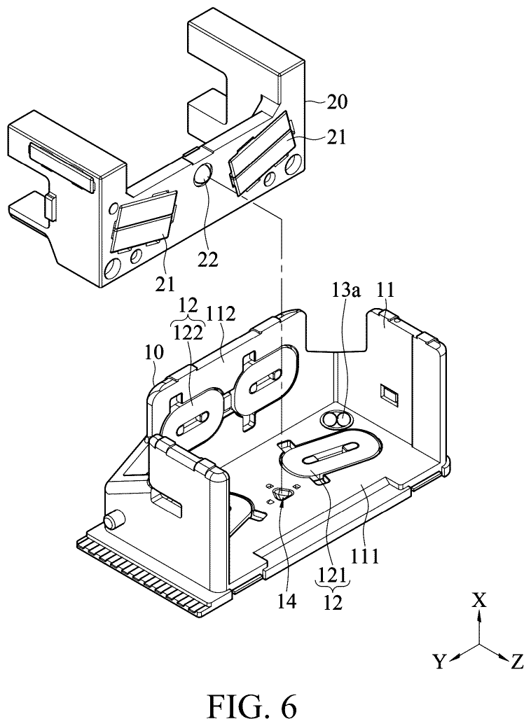

Next, refer to FIG. 6. FIG. 6 is a three-dimensional exploded view of a fixing base and a prism bracket according to a second embodiment. The same structure and connection relationship in the second embodiment as those in the first embodiment are not further described. A main difference between this embodiment and the first embodiment is a quantity of balls arranged on the fixing base 10. In this embodiment, at least two of the plurality of balls 13a are arranged on one side of the bottom surface 111 of the body 11, and at least other two of the balls 13a are arranged on the other side of the bottom surface 111 of the body 11. In FIG. 6, only two balls 13a on the right side may be seen, and the two balls 13a are arranged in a circular groove, to limit a rolling range of the two balls 13a. In addition, a corresponding circular groove may also be provided on the bottom of the prism bracket 20, to better limit the rolling range of the two balls 13a after assembly of the groove and the prism bracket. Moreover, in this embodiment, although not shown in FIG. 6, two balls 13a and a circular groove are also provided in the corresponding position on the left side of the fixing base 10, which are the same as those on the right side.

In this way, in addition to arranging a larger ball 13 as in the first embodiment, at least two balls 13a may also be arranged as in the second embodiment to reduce the friction between the fixing base 10 and the prism bracket 20 during relative motion through point contact, so that the movement is smoother, to alleviate the problem of jitter in the OIS function structure that may be caused by the motor when switching at small angles due to the dynamic and static friction.

Although the present invention is disclosed above in the foregoing embodiments, the embodiments are not intended to limit the present invention. Any person skilled in the art may make some modifications and improvements without departing from the spirit and scope of the present invention. Therefore, the patent protection scope of the present invention is subject to the scope of appended claims of this specification.

Certainly, the present invention may have various other embodiments. Without departing from the spirit of the present invention and its essence, a person skilled in the art may make various corresponding changes and modifications according to the present invention, but these corresponding changes and modifications shall fall within the protection scope of the claims of the present invention.

What is claimed is:

1. A prism motor module, comprising:
a fixing base, comprising:
a body, having a bottom surface and a side surface perpendicular to the bottom surface;
a driving module, comprising a first coil assembly and a second coil assembly, wherein the first coil assembly is arranged on the bottom surface, and the second coil assembly is arranged on the side surface;
two balls, respectively arranged on two opposite sides of the bottom surface of the body; and
a limiting groove, provided on the bottom surface of the body;
a prism bracket, arranged on the fixing base, wherein the prism bracket comprises a first magnet module and a guide shaft, the first magnet module corresponds to the first coil assembly, and the guide shaft correspondingly abuts against the limiting groove, causing the prism bracket to rotate around a first axis with the guide shaft as an axis;
a prism carrier, arranged on the prism bracket, wherein the prism carrier comprises a second magnet module corresponding to the second coil assembly, causing the prism carrier to rotate around a second axis, and the second axis is perpendicular to the first axis;
a prism, arranged on the prism carrier; and
a limiting structure, arranged between the prism bracket and the prism carrier, to restrict movement of the prism carrier on a plane formed by the second axis and a third axis, wherein the third axis is perpendicular to the first axis and the second axis.

2. A prism motor module, comprising:
a fixing base, comprising:
a body, having a bottom surface and a side surface perpendicular to the bottom surface;
a driving module, comprising a first coil assembly and a second coil assembly, wherein the first coil assembly is arranged on the bottom surface, and the second coil assembly is arranged on the side surface;
a plurality of balls, wherein at least two of the plurality of balls are arranged on one side of the bottom surface of the body, and at least other two of the plurality of balls are arranged on the other side of the bottom surface of the body; and
a limiting groove, provided on the bottom surface of the body;
a prism bracket, arranged on the fixing base, wherein the prism bracket comprises a first magnet module and a guide shaft, the first magnet module corresponds to the first coil assembly, and the guide shaft correspondingly abuts against the limiting groove, causing the prism bracket to rotate around a first axis with the guide shaft as an axis;
a prism carrier, arranged on the prism bracket, wherein the prism carrier comprises a second magnet module corresponding to the second coil assembly, causing the prism carrier to rotate around a second axis, and the second axis is perpendicular to the first axis;
a prism, arranged on the prism carrier; and
a limiting structure, arranged between the prism bracket and the prism carrier, to restrict movement of the prism carrier on a plane formed by the second axis and a third axis, wherein the third axis is perpendicular to the first axis and the second axis.

3. The prism motor module according to claim 1, wherein the limiting structure comprises a first accommodating groove, a first rolling member, a second accommodating groove, and a second rolling member, the first accommodating groove and the first rolling member are correspondingly arranged on one side of the prism bracket and the prism carrier on the second axis, the first rolling member rolls in the first accommodating groove, the second accommodating groove and the second rolling member are correspondingly provided on the other side of the prism bracket and the prism carrier on the second axis, and the second rolling member rolls in the second accommodating groove.

4. The prism motor module according to claim 3, wherein the first accommodating groove and the second accommodating groove are respectively provided on one of the prism bracket and the prism carrier, and the first rolling member and the second rolling member are respectively arranged on the other of the prism bracket and the prism carrier.

5. The prism motor module according to claim 3, wherein the first rolling member is a metal ball or a ceramic ball.

6. The prism motor module according to claim 3, wherein the first rolling member is a metal roller or a ceramic roller, and an axial direction of the first rolling member is parallel to the second axis.

7. The prism motor module according to claim 3, wherein the second rolling member is a metal ball or a ceramic ball.

8. The prism motor module according to claim 3, wherein the second rolling member is a metal roller or a ceramic roller, and an axial direction of the second rolling member is parallel to the second axis.

9. The prism motor module according to claim 2, wherein the limiting structure comprises a first accommodating groove, a first rolling member, a second accommodating groove, and a second rolling member, the first accommodating groove and the first rolling member are correspondingly arranged on one side of the prism bracket and the prism carrier on the second axis, the first rolling member rolls in the first accommodating groove, the second accommodating groove and the second rolling member are correspondingly provided on the other side of the prism bracket and the prism carrier on the second axis, and the second rolling member rolls in the second accommodating groove.

10. The prism motor module according to claim 9, wherein the first accommodating groove and the second accommodating groove are respectively provided on one of the prism bracket and the prism carrier, and the first rolling member and the second rolling member are respectively arranged on the other of the prism bracket and the prism carrier.

11. The prism motor module according to claim 9, wherein the first rolling member is a metal ball or a ceramic ball.

12. The prism motor module according to claim 9, wherein the first rolling member is a metal roller or a ceramic roller, and an axial direction of the first rolling member is parallel to the second axis.

13. The prism motor module according to claim 9, wherein the second rolling member is a metal ball or a ceramic ball.

14. The prism motor module according to claim 9, wherein the second rolling member is a metal roller or a ceramic roller, and an axial direction of the second rolling member is parallel to the second axis.

15. The prism motor module according to claim 1, wherein the fixing base further comprises a magnetic attraction member arranged on the bottom surface and located below the first coil assembly.

16. The prism motor module according to claim 2, wherein the fixing base further comprises a magnetic attraction member arranged on the bottom surface and located below the first coil assembly.

17. The prism motor module according to claim 1, wherein the prism carrier further comprises a magnet, the prism bracket further comprises a magnetic attraction member, and the magnet and the magnetic attraction member are arranged in corresponding positions.

18. The prism motor module according to claim 2, wherein the prism carrier further comprises a magnet, the prism bracket further comprises a magnetic attraction member, and the magnet and the magnetic attraction member are arranged in corresponding positions.

19. The prism motor module according to claim 1, wherein the guide shaft is in the shape of a metal column or a ceramic column, and an end surface abutting against the limiting groove is a circular arc surface.

20. The prism motor module according to claim 2, wherein the guide shaft is in the shape of a metal column or a ceramic column, and an end surface abutting against the limiting groove is a circular arc surface.
